(19) United States
(12) Patent Application Publication
(10) Pub. No.: US 2022/0007144 A1
(43) Pub. Date: Jan. 6, 2022

(54) A method and system to identify mode of transportation of cellular users based on cellular network data

(71) Applicant: CELLINT TRAFFIC SOLUTIONS LTD., Lod (IL)

(72) Inventors: Joseph Kaplan, Rishon Lezion (IL); Ofer Avni, Gizo (IL)

(21) Appl. No.: 17/282,766

(22) PCT Filed: Sep. 24, 2019
(86) PCT No.: PCT/IL2019/051054

§ 371 Date: Apr. 4, 2021

Related U.S. Application Data
(60) Provisional application No. 62/741,003, filed on Oct. 4, 2018.

(51) Int. Cl. H04W 4/029; G01S 19/46

(52) U.S. Cl. CPC H04W 4/029; G01S 19/46

(57) ABSTRACT

A system and method that identifies mode of transportation and transportation patterns of users by matching the vehicle location information and other available information to cellular location data.

### BACKGROUND

In the last decades much has been done to supply information to the public about public transportations vehicles (buses, trams etc.) availability, in addition to publishing public transportation route and planned time of each vehicle at stops, vehicle location throughout their route is monitored, usually by GPS, and anticipated arrival time to the next stop is reasonably predicted. Proliferation of cheap and compact GPS receivers had the effect that Automatic Vehicle Location (AVL) systems today almost exclusively use satellite based locating systems to monitor vehicles location in real time and supply vehicle locations frequently during their travel.

Much less information is available about public transportation passengers, where they board the vehicle, how much time and distance they travel and where they unboard the vehicle, which mode of transportation they are using in each step, etc. This information, when accumulated for the long range can teach us about persons and crowds transportation habits and preferences. Such information is very much needed by the public transportation companies, by the authorities (municipal, metropolitan, county, state and nation-wide) and others, for numerous purposes such as short and long range public transportation planning, such as adding bus routes between destinations or changing the frequency of public transportation schedules etc., infrastructure decisions and general transportation planning, such as synchronizing different modes of transportation etc.

Currently this information is collected sporadically, using inaccurate and inefficient methods, such as phone surveys, which rely on people's memory and collaboration and are very un-reliable, phone apps which supply inaccurate location when GPS is not available, and biased data for their specific population segments, thus this data can't be extrapolated for quantities of people going from one place to another based on this partial data. Current app-based systems have no means of generating enough statistics from all modes of transportation, differentiating between private transportation and different modes of public transportation. In many cases these solutions also violate the app. users privacy. The cellular network data on the other hand, is very ubiquitous and does include proper statistics of all population segments, but the accuracy of the data which is passively extracted from the network isn't enough to correlate it to a specific road/street, thus not enabling many types of analysis. This was true until patents U.S. Pat. Nos. 6,947,835 and 7,783,296 where invented.

In patents U.S. Pat. Nos. 6,947,835 and 7,783,296 Kaplan et al demonstrated methods to correlate a phone to a specific route, based on passive communication with the network and find its accurate location. The methods present an initial step of generating a signature for each route by correlating Cellular location information with GPS data generated for the same phone. These methods demonstrate the benefit of combining GPS data and Cellular data for accurate location detection. However, this method requires mapping procedures using handover data extracted at the handset level, which can be extracted only from rooted handsets with specific apps, thus limiting the amount of data that can be gathered with this method and require dedicated drives and significant investment to map all the relevant routes (roadways, railways, waterways etc.). If there is a need to monitor an entire road & rail network in a metro area for public transportation analysis, this method becomes very expensive and awkward.

Attempts to generate road signatures from other signaling data (not handovers) wasn't successful as the data recorded on the phone side is very partial and the signature is not continuous enough to generate dense enough accurate locations to match a phone to a specific road/street/route.

There is a need to develop a system and a method for a comprehensive and cost effective way to generate cellular road signatures for all relevant roadways in a cost effective manner (regardless if the mapping phones are rooted or not), identify Public transportation users, their public transportation use, both sporadic trips and long term use habits, their boarding and un-boarding locations etc. This data can be used and correlated with additional information and analysis to generate the full mobility patterns of cellular network users.

### SUMMARY OF INVENTION

A method to identify mode of transportation and transportation patterns of users by matching the vehicle location information and other available information to cellular location data.

### DESCRIPTION OF THE INVENTION

Cellular control channel data is extracted from cellular networks, either by means of network connection, or through interface at the mobile handset or through any other way.

Each data element of this information includes the mobile unit identity, the cellular location indication in the form of cell/sector location or any other form and a timestamp, and may contain additional data.

This information is collected continuously for all cellular network users. The mobile unit identity data of the cellular network users can be anonymized to prevent privacy violation.

Network signaling data may also be recorded from the handset side for handsets that include GPS receivers and a software module that records the signaling messages, together with the GPS location of each message. apps that do not require mobile device rooting may be used to record those cellular events that are accessible to non-rooted handsets

The non-rooted handsets apps recording may be used in conjunction with the network data to generate full and accurate road signatures.

Light signatures or artificial signatures (i.e. less accurate) can also be generated based on cell sector map and also by using cellular prediction systems that take into account also the terrain in the area to predict the list of messages generated on a specific route and their location.

Public transportation vehicles location data is collected by the public transportation companies or other entities using GPS, another positioning satellites system or in any other way. Each location item has a time-stamp.

The system described in the current invention matches data from the two data sources to generate trip matches between vehicle trips and users of the cellular network.

The system keeps the trip matches in a database and uses this database to follow cellular network users public transportation use habits (times, routes, boarding and unboarding stations etc.).

These travel habits are then correlated with the users whereabouts: living, working, shopping recreation etc. and with trips using different modes of transportation to generate a full picture about the user mobility patterns.

Separation Between Vehicles

In order to match cellular data to a specific public transportation vehicle we need to separate the time/location relationship of this public transportation vehicle from other public/private transportation vehicles and from pedestrians. This separation should be significant enough so that passengers of vehicle will have different cellular locations relative to other vehicles passengers and Pedestrians.

A public transportation vehicle can be separated from other public transportation vehicles and from private vehicles by its location in different times during its trip. If public transportation vehicles of the same line or of different lines have a segment or several segments of their routes in which they are not separable from other vehicles the system will determine the vehicle used only when this ambiguity is cleared, which means the two or more ambiguous vehicles have route segments where their locations in the same time can be clearly differentiated.

A public transportation vehicle time/location relationship is different from private transportation vehicles in several ways:

1. The public transportation vehicle has a specific route whereas private vehicles may choose their route freely.
2. A public transportation vehicle can many times use a HOV lane and travels in different speed which relative to private transportation. This can also be due to different speed limits for different types of vehicles.
3. A public transportation vehicle stops at stations to have passengers board and un-board the vehicle
4. A public transportation vehicle starts and ends its journey many times at a public transportation hub, where private vehicles are not allowed

A public transportation vehicle time/location relationship is different from pedestrians not travelling on this vehicle in several ways:

1. The public transportation vehicle has a specific route whereas pedestrians may choose their route freely, even not using roads (staircases, allies, in building, vehicle free zones etc.).
2. A public transportation vehicle has much higher speed relative to pedestrians in most scenarios.
3. A public transportation vehicle stops at stations to have passengers board and un-board the vehicle.

Even though the system does not know the locations of all private vehicles and pedestrians at all times it can be assumed that the specific person indeed used a specific public transportation vehicle with high probability

1. If the cellular location of a person is matched with a specific public transportation vehicle at several different locations and times which are far away from each other
2. If there are no places between the times detected in (1) above in which the cellular location of this person diverts from the Vehicle location, excluding cases of cellular network changes as detailed below.

The confidence level of a trip match is a function of the number of matching events and the time/location difference between them.

If the system knows that the specific user is a public transportation user, or even better off, that the specific user is a repeated user of the same line within a similar daily time range (A person usually travelling to or from work, a person going to a weekly event etc.) this will increase the probability of matching this person to a specific public transportation vehicle and require less matching events and/or lower time/location difference.

Time Differences Between Data Sources

There may be some time differences between the vehicle location data source and the

Cellular location data source. The cellular network data source time is fixed for all network feeds but the feeds per vehicle may have slightly different times. These differences may be checked and identified and a fixed time difference may be determined between each two datasets. Another possibility is to find the best match within a given range of positive or negative offset per vehicle. The time difference generating the best match is the same for all drives of the same vehicle.

Route Signatures

Route signature is a partitioning of the route to a list of segments with one or more cell/sector serving each such segment.

Route Signature Generation

Route signature can be generated in the following ways:

1. By using phones with a GPS travelling on the route of a vehicle and record the cellular signaling data and GPS data for the phones using a simple app that does not require phone rooting , and completing the data by using network data with location indication for the same phone. There is a similar delay between the same messages when recorded from the handset and extracted from the cellular network. This delay is a result of several reasons such as different clocks used by the phone and by the network data extraction mechanism and the processing delay by the cellular network. In order to create road signatures, the sequence of control messages on the signaling data from the network side is matched with the partial sequence available on the handset side by looking for handset generated and network generated messages which have identical data (operation type, cell ID etc.). Then the time offset between the handset data and the network data is identified by looking for such message pairs (one on the network side and one on the handset side) that have similar time offsets between the handset data and the network data. Once the handset-network time offset is known the control channel messages on the network side are assigned GPS coordinates from the handset side using this offset. If the offset corrected time of a network event falls between 2 GPS times (and locations) of the handset data, the relative location is calculated assuming constant speed between these 2 GPS locations or any other way. Doing this to all messages on the network side creates a complete and high resolution signature that can determine the street/route/road on which the handset is traveling, and its exact location in short intervals. The process of filling the gaps of missing messaged or missing data points can be done both directions if needed, and the dataset from the handset can also fill in gaps in the other dataset from the network in case some data will be missing.
2. Other way to generate such cellular signature is by using a cellular coverage map, which may be derived from cell/sectors location and azimuth, and may also be generated by a prediction system that takes into account the terrain for this calculation, or may be generated in any other form. This map is intersected with the route coordinates from the GIS system to generate the route signature. This map may contain several cell/sections per route segment, for example the 3 highest signal cell/sectors from the cellular operator's site information file or prediction system.

During the operation of the system described in the current invention, GPS location and cellular location are matched. After they are matched with high reliability each cellular location may be correlated with a GPS location at the same time. These pairs of cellular locations and GPS locations can be used for signature update. The system may alert on cellular coverage changes in parts of the route or implement signature change in view of such changes automatically.

Route signature preprocessing and matching with public vehicle locations

The route signature is preprocessed by correlating it with the GPS data and timestamp in the vehicle location data for a specific trip made by a vehicle and generating a list of time stamps, each having one or more cellular location information (e.g. cell/sectors or signature related location, etc.). This list of cells/locations are the valid points for the vehicle between the current time stamp and the next time stamp during the vehicle trip.

The system performs matching of the cellular location information and the vehicle location information to detect Cellular users who used the specific vehicle during a specific trip. A time offset can be allowed to compensate for time differences between the cellular location data source and the vehicle location data source. The offset can be a positive number (which is the offset) or zero (no offset) in case of time calibration between the 2 data sources.

One of ways to perform this matching is using the cell lists with timestamps generated by preprocessing the route signature against the vehicle data.

This cells list with timestamps is matched to the cellular network feed within the time of the vehicle trip. The matching is performed for continuous sequences of cellular locations of each cellular user within the timeframe of the vehicle trip expanded by a time offset.

In order to achieve high efficiency of the matching process, The list of all distinct cells/sectors that appear in the cell list for a specific vehicle trip can be used for initial rejection of all cellular network users whose data for the trip period does not contain at least L (where L>1) distinct Cell/sectors from this list. L may vary according to known user public transportation usage habits and/or the required confidence level for the matching.

A match between the 2 data sources is defined when there is a matching cell between the list of cells and the cellular data within the same timeframe expanded by the time offset.

A mismatch between the 2 data sources is defined when there is a cell in the cellular data that does not match any of the cells in the list of cells within the same timeframe contracted by the time offset.

Of course a user may have been on the vehicle for part of the trip, between his/hers time and location of boarding and his/hers time and location of un-boarding the vehicle.

Therefore the system is looking for sequences of continuous matches, such as may occur between boarding and un-boarding. Of course not all the cells in the cell list need to be matched, and also there may be segments for which none of the cells in the cell list for this segment is matched, as long as all cellular network cell/sector locations within a sequence are matched.

The number of matches in such sequence and the time and/or location difference between them will determine the strength or the confidence level of matching. If the strength of matching is above a specific threshold the system determines that the user was on the vehicle throughout the time and location of the sequence of matches. This is called a trip match.

This threshold may be different (lower) if the system has prior knowledge of the cellular user travel habits (such as a person that frequently uses public transportation or even a user that used vehicles on a similar route in similar times).

Data about the location of the public transportation vehicles can come from AVL system, as well as from any other source, such as mobile apps, ANPR, Bluetooth tracking, Wi-Fi tracking, Satellite photos, modem data communication (directly or via the mobile network data).

A journey can be comprised of several trips, each of them is using a different mode of transportation. The system can differentiate between the different trips based on the algorithms above, as well as by analyzing other data layers in the GIS system and meta data, such as home location, train station location and work location.

Analysis Related to User Whereabouts

User whereabouts: Living, working, shopping, recreation etc. can be generated from the analysis of cellular network data for this user over time. Users living whereabouts may be derived from the user location at night time and weekends, users working whereabouts can be derived from the user location during working hours in business days. Working can be substituted for studying in school, college, university and alike for pupils and students. It may be correlated with any GIS reference database, such as school/university locations. User shopping whereabouts can be correlated with after working hours for working people and all day hours for non-working people. It may be correlated with shopping malls and outlets location and may have repetitive patterns, and similar analysis applies to user recreation whereabouts. Special events whereabouts such as a rock concert, sport event, exhibition or convention or demonstration that are held at specific time/period in a specific location when correlated with public transportation routes leading to/from the venue location may also be used for public transportation usage analysis, and may even be correlated and analyzed specifically for event attenders that may also be identified by cellular network data analysis.

Users whereabouts, together with a list of public transportation stations may be used for locating the transportation modes the user utilizes to move between his/her different whereabouts and determine the user's boarding and un-boarding stations, by matching the trip match sequences of this user to his/hers whereabouts.

Other types of analysis are available by matching the data above with other data layers in the GIS system and meta data, such as dedicated public transportation routes, different speed limits, etc.

Public Vehicles Occupancy Analysis

The data accumulated for a time period can supply statistics about public vehicles occupancy in the different segments of its trip in different times of day for working days, weekends and holidays by counting and analyzing the trips per vehicle in different times. This data can be correlated with and calibrated against results of actual average passenger counts to enable ongoing vehicle occupancy statistics.

Changes in the Cellular Network or Terrain

In case of changes in the cellular network or terrain there may be single cases or sequences of non-matching cells, preceded and/or followed by trip match sequences for the same cellular user.

The system will keep all the trip matches data in a database and the sequences of mismatches which have a preceding and/or following trip matches for the same user in a different database.

These 2 databases will be then used to detect, analyze and fix changes in the signature database which are due to changes in the cellular network or terrain. The methodology of the signature fix is based on correlating the locations of the added/different network events with the GPS location data as described in the signature generation section above.

Identifying People on Ride Share Modes

Each ride share application has its own communication mechanism and as a result its own frequency of communication and density patterns of messages. Based on the patterns of data transfer for a specific phone over the cellular network, the system can identify if the phone is using a ride share application before, during and after the ride, thus identify users and drivers of ride share applications.

Identifying People on Bikes

Since bike travels in different speeds than regular traffic in many traffic and terrain scenarios, these speed difference can used to differentiate them, as well as identification of dedicated routes for bikes. Some of the scenarios include:

1. On open roadway—bikes will be slower than the traffic
2. On very congested roads—bikes will be faster than the traffic
3. In long uphill roads bikes will be much slower than traffic
4. Identify a route which is bike only, and track the same phone before and after through its trip

Identifying Trucks

Using hubs of trucks, and/or speed limit differences for regular traffic vs. trucks and/or other GIS layers and/or meta data can help differentiate trucks from other vehicles

Using App on the Phone to Collect Data on Other Users

If an app is used to collect data from user's cell phone, the phone can sense other phones in close proximity along a route, and if the app user is known to use public transportation, other phones on that public transportation vehicle can be identified as well, regardless if they have the app or not.

Same method can be used to track origin destination of these other phones based on data collected from many app users, as well as travel time and speed between points along the route.

1. A method and a system to identify mode of transportation on which the phone is traveling, comprised of:
Collecting data with location indication from mobile device
Collecting data about public transportation location from external sources
Matching between the two datasets

2. A method and a system to create cellular signature for a route comprised of:
Collecting signaling data from the cellular network
Collecting signaling data with location indication from the handset
Matching between the two datasets and identify missing information in one of the sets
Filling in the gaps of the missing information in one dataset by using the data from the other dataset

3. A method and system to perform matching of cellular location information of a mobile device and a vehicle location information characterized in that:
Generating a list of time stamps for the mobile device, each having one or more cellular location information
Matching continuous sequences of cellular locations of the mobile device to sequences of location information of the vehicle

4. A method and system to perform matching of data from two data sources on a cellular network characterized in that:
Generating a list of time stamps, each having one or more cellular location information
Matching continuous sequences of cellular locations of both mobile devices

5. A Method and system as in claim 4 characterized in that:
generating a list of time stamps, each having one or more cellular location information
A match between the 2 data sources is defined when there is one or more matching cells between the list of cells and the cellular data within the same timeframe
A mismatch between the 2 data sources is defined when there is at a cell or more in the cellular data that does not match any of the cells in the list of cells within the same timeframe

6. A method for correlating a cellular phone with a GPS device comprising of:
Collecting signaling data from at least one mobile device
Collecting GPS location data from at least one GPS device
Matching between the two datasets
